(19) United States
(12) Patent Application Publication
(10) Pub. No.: US 2008/0119155 A1
(43) Pub. Date: May 22, 2008

(54) Coordinated antenna array and multinode synchronization for integer cycle and impulse modulation systems

(75) Inventor: Joseph A. Bobier, Sunrise, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: xG Technology, Inc., Sarasota, FL (US)

(21) Appl. No.: 11/985,789

(22) Filed: Nov. 16, 2007

Related U.S. Application Data
(60) Provisional application No. 60/859,778, filed on Nov. 17, 2006.

(51) Int. Cl. H04B 7/00

(52) U.S. Cl. 455/275

(57) ABSTRACT

An improved antenna arrangement and synchronization system for use when multiple radio base stations, using a deterministic over the air MAC layer, are located within overlapping coverage areas is disclosed and more specifically the method described here discloses an improved antenna and coordination arrangement for use at the base station which will eliminate over the air collisions while doubling the effective data rate of each base station. The result being large area networks which all share exactly the same radio spectrum without mutual interference and with little effort required to expand a single base station system into a grid of cooperative base stations forming a coverage area of ubiquitous coverage and multiplied data capacity.

### CROSS-REFERENCE TO RELATED APPLICATION

The present application claims the benefit of previously filed co-pending Provisional Patent Application Ser. No. 60/859,778.

### FIELD OF THE INVENTION

This invention addresses the need to transport high bit-rate data over wireless means using specially modulated radio frequency carrier waves. Specifically, this disclosure describes an improved antenna arrangement and synchronization system for use when multiple radio base stations, using a deterministic over the air MAC layer, are located within overlapping coverage areas.

### BACKGROUND OF THE INVENTION

Radio transmission of information traditionally involves employing electromagnetic waves or radio waves as a carrier. Where the carrier is transmitted as a sequence of fully duplicated wave cycles or wavelets, no information is considered to be transmissible. To convey information, historically, the carrier has superimposed on it a sequence of changes that can be detected at a receiving point or station. The changes imposed correspond with the information to be transmitted, and are known in the art as “modulation”.

Where the amplitude of the carrier is changed in accordance with information to be conveyed, the carrier is said to be amplitude modulated (AM). Similarly, where the frequency of the carrier is changed in accordance with information to be conveyed, either rarified or compressed wave cycles are developed, and the carrier is said to be frequency modulated (FM), or in some applications, it is considered to be phase modulated. Where the carrier is altered by interruption corresponding with information, it is said to be pulse modulated.

Currently, essentially all forms of the radio transmission of information are carried out with amplitude modulation, frequency modulation, pulse modulation or combinations of one or more. All such forms of modulation have inherent inefficiencies. For instance, a one KHz audio AM modulation of a Radio Frequency (RF) carrier operating at one MHz will have a carrier utilization ratio of only 1:1000. A similar carrier utilization occurs with corresponding FM modulation. Also, for all forms of currently employed carrier modulation, frequencies higher and lower than the frequency of the RF carrier are produced. Since they are distributed over a finite portion of the spectrum on each side of the carrier frequency, they are called side frequencies and are referred to collectively as sidebands. These sidebands contain all the message information and it has been considered that without them, no message can be transmitted. Sidebands, in effect, represent a distribution of power or energy from the carrier and their necessary development has lead to the allocation of frequencies in terms of bandwidths by governmental entities in allocating user permits within the radio spectrum. This necessarily limits the number of potential users for a given RF range of the spectrum.

To solve the bandwidth crisis in the RF Spectrum, multiple access systems were developed. Multiple Access Systems are useful when more than one user tries to transmit information over the same medium. The use of multiple access systems is more pronounced in Cellular telephony; however, they are also used in data transmission and TV transmission. There are three common multiple access systems. They are:
1. Frequency Division Multiple Access (FDMA)
2. Time Division Multiple Access (TDMA)
3. Code Division Multiple Access (CDMA)

FDMA is used for standard analog cellular systems. Each user is assigned a discrete slice of the RF spectrum. FDMA permits only one user per channel since it allows the user to use the channel 100% of the time. FDMA is used in the current Analog Mobile Phone System (AMPS).

In a TDMA system the users are still assigned a discrete slice of RF spectrum, but multiple users now share that RF carrier on a time slot basis. A user is assigned a particular time slot in a carrier and can only send or receive information at those times. This is true whether or not the other time slots are being used. Information flow is not continuous for any user, but rather is sent and received in “bursts”. The bursts are re-assembled to provide continuous information. Because the process is fast, TDMA is used in IS-54 Digital Cellular Standard and in Global Satellite Mobile Communication (GSM) in Europe. In large systems, the assignments to the time/frequency slots cannot be unique. Slots must be reused to cover large service areas.

CDMA is the basis of the IS-95 digital cellular standard. CDMA does not break up the signal into time or frequency slots. Each user in CDMA is assigned a Pseudo-Noise (PN) code to modulate transmitted data. The PN code is a long random string of ones and zeros. Because the codes are nearly random there is very little correlation between different codes. The distinct codes can be transmitted over the same time and same frequencies, and signals can be decoded at the receiver by correlating the received signal with each PN code.

The great attraction of CDMA technology from the beginning has been the promise of extraordinary capacity increases over narrowband multiple access wireless technology. The problem with CDMA is that the power that the mobiles are required to transmit goes to infinity as the capacity peak is reached. i.e. the mobiles will be asked to transmit more than their capacity allows. The practical consequence of this is that the system load should really be controlled so that the planned service area never experiences coverage failure because of this phenomenon. Thus CDMA is a tradeoff between maximum capacity and maximum coverage.

When a radio base station communicates with multiple end user devices using a radio channel which is fully occupied by the signal from the base station, and a second base station must be added to the same geographical area to enhance system capacity or signal propagation, a means of sharing of the radio channel is required so as to eliminate mutual interference from one base station to the next. Even further, more than two base stations might be necessary to fill the coverage and bandwidth requirements of the service area. Traditionally, systems that are contention based, such as WiFi or 802.11, must compete for air time. This invariably results in competition for time and collisions of signals from one base station to the next. Thus collisions result in data errors and reduced overall bandwidth. Deterministic systems such as the TDMA method assign specific time slots or durations of time during which base stations and end user devices may communicate. This creates an opportunity to synchronize transmission times from one base station to another, allowing efficient and interference free communications.

In essence, it is an object of this invention to disclose an improved antenna arrangement and synchronization system for use when multiple radio base stations using integer cycle or impulse type modulation, and using a deterministic over the air MAC layer, are located within overlapping coverage areas.

### BRIEF SUMMARY OF THE INVENTION

The invention disclosed in this application uses any integer cycle or impulse type modulation and more particularly is designed to work with a method of modulation named Tri-State Integer Cycle Modulation (TICM) which has been previously disclosed in U.S. Pat. No. 7,003,047 issued Feb. 21, 2006 filed by the inventor of this disclosure.

The method described here discloses an improved antenna and coordination arrangement for use at the base station which will eliminate over the air collisions while doubling the effective data rate of each base station. The result will be large area networks which all share exactly the same radio spectrum without mutual interference and little effort required to expand a single base station system to a grid of cooperative base stations forming a coverage area of ubiquitous coverage and multiplied data capacity.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a representation of an omni-directional antenna base station.

FIG. 2 is a representation of a four sector antenna base station.

FIG. 3 is a representation of grid of four sector antenna base stations.

FIG. 4 is a block schematic diagram of a four sector antenna base station circuitry.

FIG. 5 is a block schematic diagram of an alternative four sector antenna base station circuitry.

### DETAILED DESCRIPTION OF THE INVENTION

The invention disclosed in this application uses any integer cycle, ultra-wide band or impulse type modulation and more particularly is designed to work with a method of modulation named Tri-State Integer Cycle Modulation (TICM) which has been described above.

Consider a base station which is equipped with a single omni-directional antenna as shown in FIG. 1. If such base station is using a TDMA system wherein each end user is assigned, occupying, and using its time slot, and all time slots are fully assigned, the radio spectrum will be considered to be fully utilized because communication between the base station and any given end user device will always be active. The channel is full. Placing another base station in the same geographic coverage area will be detrimental to both base stations because the radio signals will overlap and communications will be subject to mutual interference. Thus base stations with overlapping coverage areas on the same radio frequencies will be problematic. Traditional cellular systems use FDMA or multiple radio frequencies to segregate coverage areas to avoid interference. Systems that have limited radio bandwidth may not have the luxury of multiple radio frequencies to accommodate traditional FDMA architectures.

In the preferred embodiment of this invention we replace the omni directional antenna with four antennas, each with a radiation pattern of 90 degrees as shown in FIG. 2. Now we have antennas A, B, C and D. Also, further suppose that antennas A and C are oriented opposite directions and antennas B and D are oriented opposite directions to each other. Thus we have four antennas oriented 90 degrees apart, one to another forming a coverage area of 360 degrees.

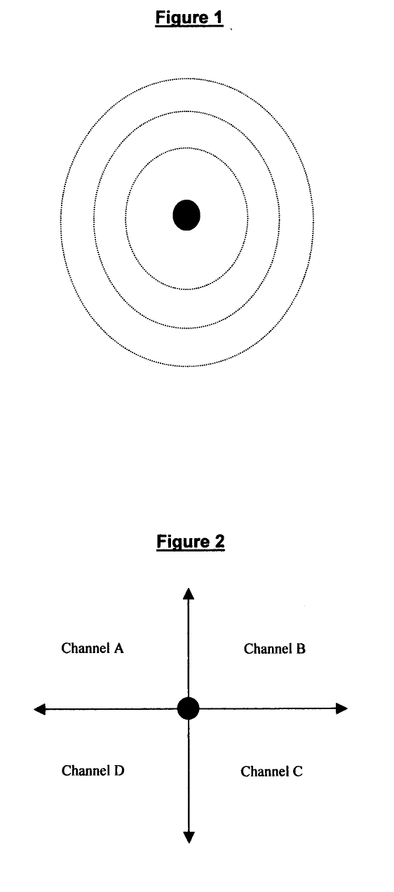

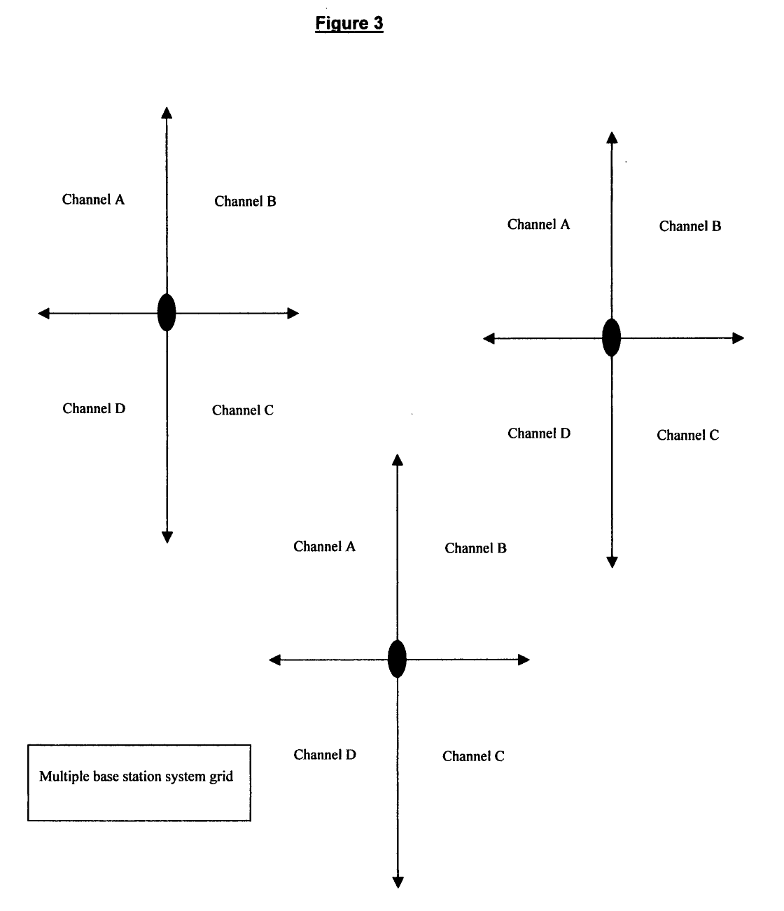

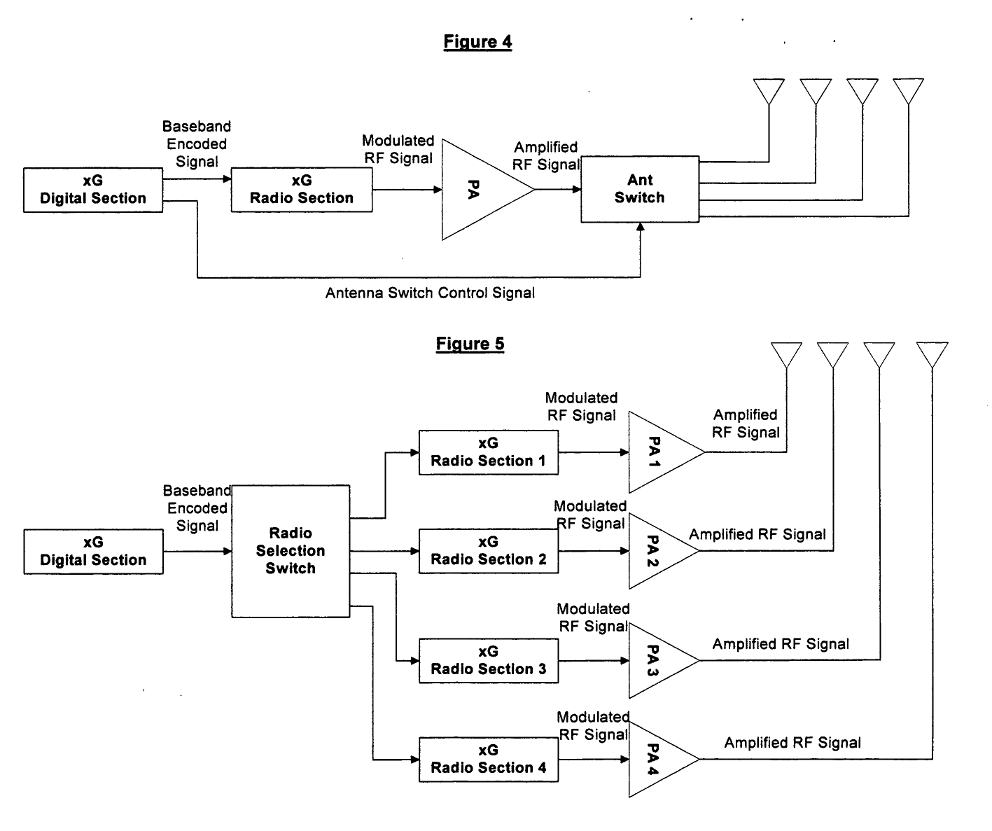

Further, program the base station, which is equipped with four antenna jacks or outlets, each corresponding to one of the four antennas, to form four independent radio data streams or signals. That is to say that each antenna jack will transmit an independent radio stream to the group of end user devices that are located within its coverage area. A schematic representation of two types of circuitry to accomplish this is shown in FIGS. 4 and 5 where FIG. 4 shows a method using only one antenna switch and one RF section and FIG. 5 uses one control switch and four RF sections. Thus, using circuitry as shown in FIG. 4 or 5 the radio channel can be divided into four sub-channels defined by the geographic orientation of the antenna.

If the radio signals were allowed to transmit from each antenna without coordination of some sort, antenna A might be transmitting while antenna B is receiving. Thus leaked radiation from antenna A might de-sensitize or interfere with antenna B simply because the antennas are co-located in close proximity on the same tower. The solution then is to coordinate the antennas so that they all are either transmitting or receiving at the same time. Therefore in a single tower and base station installation, each antenna will transmit and receive at exactly the same time as every other antenna on the same base station. The fact that each antenna supports an independent data stream causes a cumulative effect on the total base station capacity. In effect, the single channel has been multiplied in capacity by 4. This is the preferred method where only a single base station is used in a geographical area without other similar base stations.

However further complications will arise when additional base stations are added to the coverage area, essentially reverting back to the original problem of a fully utilized channel with no time for additional time slots. Therefore a further enhancement is added which will allow the sharing of airtime between base stations.

To make time slots available for the second base station, each of the four base station antenna ports will reduce its transmission time to exactly ½ of the full transmission time. Thus, the base station has reduced its quadrupled capacity to ½, or effectively now doubled the original capacity of a single antenna equipped base station.

The secondary base station, upon power-up, will first monitor the radio channel, listening for the existence of a primary or first base station. Upon hearing that indeed signal is in the air, the second base station will assume use of the 50% of the transmission time that is not being used by the first base station. By monitoring the timing marks built into the MAC protocol of the first base station, the second base station is capable of coordinating and working exactly when the airwaves are clear. Mutual interference between base stations is avoided. Thus the first base station is the “master” while all secondary base stations are “slaves”.

Since the antenna arrangement for each base station is using an antenna beam width of 90 degrees, additional base stations can be located in a grid pattern with antennas arranged facing each other, one base station to the next as shown in FIG. 3. This allows for very close location of multiple base stations, with even very strong signal densities to the end users, giving strong coverage and a high quality of service with no mutual interference and all using exactly the same radio frequencies.

Since certain changes may be made in the above described RF signal modulation and reception method without departing from the scope of the invention herein involved, it is intended that all matter contained in the description thereof or shown in the accompanying figures shall be interpreted as illustrative and not in a limiting sense.

What is claimed is:

1. A coordinated antenna array and multi-node synchronization system for radio frequency transmission and reception comprising;
an antenna array having four antennas with each of said antennas having a radiation pattern of 90 degrees and horizontally aligned in a circular pattern such that said antenna array is capable of constantly transmitting or receiving in a full 360 degree horizontal pattern; and,
a base station radio operating four independent radio signals over the same frequency spectrum having four antenna outlets with one of each of said antenna outlets electrically connected to one of each of said antennas and with each of said antenna outlets time coordinated such that each antenna of said antenna array is receiving and transmitting one of the four independent radio frequency signals over the same radio frequencies at the same time.

2. The coordinated antenna array and multi-node synchronization system for radio frequency transmission and reception further comprising;
said base station radio operating four independent radio signals over the same frequency spectrum having four antenna outlets with one of each of said antenna outlets electrically connected to one of each of said antennas and with each of said antenna outlets time coordinated such that each antenna of said antenna array is receiving and transmitting one of four independent radio frequency signals over the same radio frequencies at the same time but also only transmitting and receiving fifty percent of the total available transmit or receive time;
said base station having a medium access control system with a superframe structure containing timing marks to control timeslots of radio frequency receptions and transmissions; and,
one or more additional antenna arrays having similar antenna and base station configurations to said antenna array and wherein each additional antenna array upon power up detects the radio frequency transmission of said antenna array or one of said additional antenna arrays that is transmitting to identify said superframe containing said timing marks and selects the opposite fifty percent of the total available transmit or receive time not being used by the already transmitting antenna array to transmit or receive.
